(19) United States
(12) Patent Application Publication
(10) Pub. No.: US 2016/0371712 A1
(43) Pub. Date: Dec. 22, 2016

(54) Method and Score Management Node For Supporting Service Evaluation

(71) Applicant: Telefonaktiebolaget LM Ericsson (publ), Stockholm (SE)

(72) Inventors: Joerg NIEMOELLER, Sundbyberg (SE); Lisa SAWIN, Bridgewater, NJ (US)

(73) Assignee: Telefonaktiebolaget LM Ericsson (publ), Stockholm (SE)

(21) Appl. No.: 15/132,435

(22) Filed: Apr. 19, 2016

Related U.S. Application Data
(60) Provisional application No. 62/180,355, filed on Jun. 16, 2015.

(51) Int. Cl. G06Q 30/02; H04L 12/24

(52) U.S. Cl. CPC G06Q 30/0203; H04L 41/5067

(57) ABSTRACT

A method and score management node for supporting service evaluation by obtaining a perception score P reflecting a user's experience of a service delivered by means of a telecommunication network. The score management node receives network measurements (v) related to at least one service event when the service is delivered to the user, and filters the received network measurements to obtain a set of network measurements related to a specific technical asset in the network used for delivering the service. The perception score P is then determined for the technical asset based on the obtained set of network measurements. The asset-specific perception score P can be used in evaluation of the service delivered by means of the technical asset.

### CROSS REFERENCE TO RELATED APPLICATIONS

This application claims the benefit of U.S. provisional patent application No. 62/180,355, filed on Jun. 16, 2015, which is incorporated by reference.

### TECHNICAL FIELD

The present disclosure relates generally to a method and a score management node for supporting service evaluation by obtaining a perception score P reflecting a user experience of a service delivered by means of a telecommunication network.

### BACKGROUND

When a service has been delivered by means of a telecommunication network by a service provider to one or more users, it is of interest for the service provider to know whether the user is satisfied with the delivered service or not, e.g. to find out if the service has shortcomings that need to be improved in some way to make it more attractive to this user and to other users. Service providers, e.g. network operators, are naturally interested in making their services as attractive as possible to users in order to increase sales, and a service may therefore be designed and developed so as to meet the users' demands and expectations as far as possible. It is therefore useful to gain knowledge about the users' opinion after service delivery in order to evaluate the service. The services discussed in this disclosure may, without limitation, be related to streaming of audio and visual content e.g. music and video, on-line games, web browsing, file downloads, voice and video calls, delivery of information e.g. in the form of files, images and notifications, and so forth, i.e. any service that can be delivered by means of a telecommunication network.

A normal way to obtain the users' opinion about a delivered service is to explicitly ask the customer, after delivery, to answer certain questions about the service in a survey or the like. For example, the service provider may send out or otherwise present an inquiry form, questionnaire or opinion poll to the customer with various questions related to user satisfaction of the service and its delivery. If several users respond to such a poll or questionnaire, the results can be used for evaluating the service, e.g. for finding improvements to make, provided that the responses are honest and that a significant number of users have answered. An example of using survey results for estimating the opinion of users is the so-called Net Promoter Score, NPS, which is calculated from answers to user surveys to indicate the users' collected opinions expressed in the survey answers.

However, it is often difficult to motivate a user to take the time and trouble to actually answer the questions and send a response back to the service provider. Users are often notoriously reluctant to provide their opinions on such matters, particularly in view of the vast amounts of information and questionnaires flooding users in the current modern society. One way to motivate the user is to reward him/her in some way when submitting a response, e.g. by giving some present or a discount either on the purchased services or when buying future services, and so forth.

Even so, it is a problem that surveys can in practice only be conducted for a limited number of users which may not be representative for all users of a service, and that the feedback cannot be obtained in “real-time”, that is immediately after service delivery. A survey should not be sent to a user too frequently either. The obtained feedback may thus get out-of-date.

Further problems include that considerable efforts and costs must be spent to distribute a survey to a significant but still limited number of users and to review and evaluate all answers coming in, sometimes with poor results due to low responsiveness. Furthermore, the user may provide opinions which are not really accurate or honest and responses to surveys may even be misleading. For example, the user is often prone to forget how the service was actually perceived or experienced when it was delivered, even after a short while, once prompted to respond to a questionnaire. Human memory thus tends to change over time, and the response given may not necessarily reflect what the user really felt and thought at service delivery. The user may further provide the response very hastily and as simply as possible not caring much if it really reflects their true opinion. The opinion expressed may also be dependent on the user's current mood such that different opinions may be expressed at different occasions, making the response all the more erratic and unreliable.

Still another problem is that it can be quite difficult to trace an underlying reason why users have been dissatisfied with a particular service, so as to take actions to eliminate the fault and improve the service and/or the network used for its delivery. Tracing the reason for such dissatisfaction may require that any negative opinions given by users need to be correlated with certain operational specifics related to network performance, e.g. relating to where, when and how the service was delivered to these users. This kind of information is not generally available and analysis of the network performance must be done manually by looking into usage history and history of network issues. Much efforts and costs are thus required to enable tracing of such faults and shortcomings.

### SUMMARY

It is an object of embodiments described herein to address at least some of the problems and issues outlined above. It is possible to achieve this object and others by using a method and a score management node as defined in the attached independent claims.

According to one aspect, a method is performed by a score management node for supporting service evaluation by obtaining a perception score P reflecting a user experience of a service delivered by means of a telecommunication network. In this method, the score management node receives network measurements related to at least one service event when the service is delivered to one or more users. The score management node further filters the received network measurements to obtain a set of asset related network measurements related to a specific technical asset in the network used for delivering the service. The score management node then determines the perception score P for the technical asset based on the obtained set of asset related network measurements, wherein the perception score P is made available for use in evaluation of the service delivered by means of the technical asset.

According to another aspect, a score management node is arranged to support service evaluation by obtaining a perception score P reflecting a user experience of a service delivered by means of a telecommunication network. The score management node comprises a processor and a memory containing instructions executable by the processor, whereby the score management node is configured to receive network measurements related to at least one service event when the service is delivered to one or more users, and filter the received network measurements to obtain a set of asset related network measurements related to a specific technical asset in the network used for delivering the service. The score management node is further configured to determine the perception score P for the technical asset based on the obtained set of asset related network measurements, wherein the perception score P is made available for use in evaluation of the service delivered by means of the technical asset.

When employing the above method and/or score management node, the determined perception score P can be used in the service evaluation as an estimation of the users' opinion and it is possible to obtain P automatically after every time a service is delivered to the user. Further, since the perception score P is calculated from technical measurements in the network related to a specific technical asset in the network used for delivering the service, it is possible to evaluate the performance of that asset based on the perception score P. Since the calculated P is thus more or less “asset-specific”, any technical asset in the network that performs less than satisfactorily can be identified and remedied to improve the service delivery.

A computer program storage product is also provided comprising instructions which, when executed on at least one processor in the score management node, cause the at least one processor to carry out the method described above for the score management node.

The above method and score management node may be configured and implemented according to different optional embodiments to accomplish further features and benefits, to be described below.

### BRIEF DESCRIPTION OF DRAWINGS

The solution will now be described in more detail by means of exemplary embodiments and with reference to the accompanying drawings, in which:

FIG. 1 is a block diagram illustrating an example of how a score management node may be configured and operate, according to some possible embodiments.

FIG. 2 is a flow chart illustrating a procedure in a score management node, according to further possible embodiments.

FIG. 3 is a block diagram illustrating a score management node in more detail, according to further possible embodiments.

### DETAILED DESCRIPTION

The embodiments described in this disclosure can be used for supporting evaluation of a service by obtaining an estimated user opinion about the service when it has been delivered to one or more users by means of a telecommunication network. The embodiments will be described in terms of functionality in a “score management node”. Although the term score management node is used here, it could be substituted by “score management system” or similar term throughout this disclosure.

Briefly described, a perception score P is calculated that reflects a user experience of the service, based on technical network measurements made for one or more events or occasions when the service was delivered to one or more users, hereafter referred to as “service events” for short. For example, the network measurements may relate to the time needed to download data, the time from service request until delivery, call drop rate, data rate and data error rate. By finding network measurements that are related to a specific technical asset in the network used for delivering the service, the perception score P calculated therefrom will be valid for that technical asset and can be used for detecting and evaluating the performance of that technical asset.

In the following description, any network measurements related to delivery of a service to a user by means of a telecommunication network are generally denoted “v” regardless of measurement type and measuring method. It is assumed that such network measurements v are available in the network, e.g. as provided from various sensors, probes and counters at different nodes in the network, which sensors, probes and counters are commonly used for other purposes in telecommunication networks of today, thus being operative to provide the network measurements v to the score management node for use in this solution. Key Performance Indicator, KPI, is a term often used in this field for parameters that in some way indicate network performance.

Further, the term “delivery of a service by means of a telecommunication network” may be interpreted broadly in the sense that it may also refer to any service delivery that can be recorded in the network by measurements that somehow reflect the user's experience of the service delivery. Some further examples include services provided by operator personal aided by an Operation and Support System, OSS, infrastructure. For example, “Point of sales” staff may be aided by various software tools for taking and executing orders from users. These tools may also be able to measure KPIs related to performance of the services. Another example is the Customer Care personal in call centers who are aided by some technical system that registers various user activities. Such technical systems may as well make network measurements related to these activities as input to the score management node.

The network measurements v may be sent regularly from the network to the score management node, e.g. in a message using the hyper-text transfer protocol http or the file transfer protocol ftp over an IP (Internet Protocol) network. Alternatively, the score management node may fetch the measurements v from a measurement storage where the network stores the measurements once they are generated. In this disclosure, the term “network measurement v” may also refer to one or more KPIs which are commonly prepared in the network to reflect actual physical measurements in a desirable manner. The concept of KPIs is well-known as such in telecommunication networks.

Network and service operation centers of today may use detailed metrics in order to identify services, nodes or network links that do not perform well. Usually a metric is evaluated in relation to a threshold value. This evaluation may trigger an alarm or warning indicating that parts of the network do not perform as expected or required. If certain assets in the network, for example a radio cell or an application server, are repeatedly pointed out to be a bad performer, this may be an indication that certain investments or repair is necessary.

Network operation and identification of problems as described above is commonly based on some objective criteria that are embodied in, for example, a set of thresholds combined with an measured metric or KPI. However, this does not account for the problem of giving the user a good experience at service delivery. In this regard, it is the subjective perception of the user that is of interest, not the objective performance of the network. Some problems that are clearly indicated by technical measurements may go unnoticed by the user and may still provide an acceptable overall user experience. On the other hand, some situations that really bother the user might not be reflected by objective technical measurements. For example, the network might perform within expected ranges and the user might still get a bad experience compared to his/her expectation.

In this respect, it may also be noted that user perception is very individual. Two users might have completely different opinions about the same objective quality of service presented to them by the network and the services.

In this solution, all network measurements, e.g. KPIs, that are related to an particular network asset may be fed into a perception scoring model which may be realized as a scoring algorithm or the like. The outcome of this algorithm is the perception score P reflecting how a virtual human user would have perceived the service provided with that network asset involved. The system would pretend that all these KPI that are related to the network asset are only experienced by a single user.

The perception score P can then be used to evaluate the quality delivered by the network asset. If it does not provide a good service, a technician might need to further investigate the asset. Good service is in this respect not defined as functioning according to expected technical parameters, it is rather defined as being perceived by a human user as being satisfactory.

The described measurements and evaluations of quality delivered by the network, its parts and the provided services may be regarded as useful input for several operational decisions and actions.

Service Operation Centers (SOC) need to understand if there are any severe problems that need to be prioritized. A complex technical infrastructure is typically employed to support the SOC personnel in this task. The introduction of an automatically generated subjective score for network and service assets, i.e. the above-mentioned asset-specific perception score P, allows prioritizing the problems with respect to the experience they provide to users. This means that any prioritized problems that affect the users significantly can now be solved first, and so forth.

It may be of interest to invest into the right activities and into the right infrastructure. The best investment may be one that best improves customer satisfaction. A subjective asset-specific perception score P as provided by the embodiments described herein will directly allow to identify and control how a specific technical asset performs in this respect.

It will now be described how raw measurement data can be correlated and filtered. The solution described herein may be employed by using a measuring infrastructure that collects various metrics, such as KPIs, about the network and the service usage, in this description referred to as “measurements” for simplicity. This may result in a real-time, or “near real-time”, stream of these measurements or in a collection of measurements being recorded into a database at service deliveries for later scoring.

In this solution, the measurements may be correlated to identities of network assets or service IDs in order to preserve information about which assets have been involved in a service delivery. For example, the Cell ID of a radio cell might be assigned to all measured KPIs for any service sessions that were served through this particular cell.

An operation in the procedure described herein is to filter the measurement raw data so as to obtain a subset of measurements related to the network or service asset that is supposed to be scored. Asset IDs present in received raw data may be used for this operation. This can be used to obtain the subset of all those measurements that are somehow related to the asset. In the example of the asset being a radio cell, also KPIs such as video frame-rate are related to the radio cell as long as the respective video stream did pass through that cell.

A “Per Asset Filter” can be implemented with simple filter rules, to filter out the asset specific measurements. For example, “If CELLID=1234 Then DO_SCORING Else DROP” could be such a filter rule for only considering the data records where Cell number 1234 was involved. The respective KPI would then be forwarded to the scoring, or otherwise not used in the scoring procedure described herein.

A single measurement may be part of several assets. For example, if the measurement is a KPI related to the speech quality of a voice call between two mobile devices, there are two radio air interfaces and in general two radio cells involved which affect that KPI. This means that the KPI can be used in the subjective scoring of both cells, i.e. two assets.

Assets may also be scored by their type rather than every individual asset separately. If the asset is the entire radio network, then all cell IDs and related KPI are combined into an overall dataset that is then scored. This can also be helpful if the scored asset is a certain service like for example Mobile TV. In this case, all KPI of all video streaming sessions for Mobile TV may be taken into the set of input data, i.e. measurements, to be used for determining P.

Some different user models for subjective scoring will now be described. The perception scoring in this disclosure can be made individual, i.e. user-specific. This means basically that the scoring model is parameterized differently for different users. This may be referred to as every user having his/her own model. The differences come mainly from different and individual preferences and expectations of different types of users. In a possible embodiment, the perception score P may be determined for the technical asset by applying a predefined scoring algorithm on the obtained set of network measurements using a set of scoring model parameters in the scoring algorithm. In order to make the perception scoring individual, the scoring model parameters in the scoring algorithm may be individualized scoring model parameters corresponding to expectations and perceptions of a specific user to which the service was delivered.

Some different user model for subjective scoring will now be described. The perception scoring in this disclosure can be made individual, i.e. user-specific. This means basically that the scoring model is parameterized differently for different users. This may be referred to as every user having his/her own model. The differences come mainly from different and individual preferences and expectations of different types of users. In a possible embodiment, the perception score P may be determined for the technical asset by applying a predefined scoring algorithm on the obtained set of network measurements using a set of scoring model parameters in the scoring algorithm. In order to make the perception scoring individual, the scoring model parameters in the scoring algorithm may be individualized scoring model parameters corresponding to expectations and perceptions of a specific user to which the service was delivered.

The scoring model used for asset-specific scoring of P may be valid for an globally average user. This means that model parameters are used that correspond to the expectations and perceptions of an average user. Thus, the scoring model parameters in the scoring algorithm may be predefined scoring model parameters corresponding to expectations and perceptions of such an average user. This average user may then be used as a virtual user and it may be assumed that this virtual average user has experienced all KPI of the scored network or service asset. In this embodiment, the model parameters of this average user could be loaded once into the scoring algorithm and then kept for the entire scoring that is made for several service events.

In another example, it is still the KPI related to the network or service asset, that are fed into the scoring model, but the scoring model parameters may be changed for every KPI. The used scoring model may be associated to the real individual user, who has actually experienced that KPI. This example can therefore more accurately project the individual user's experience onto the asset to be scored.

This example may require that, for every new dataset of KPI to be scored, the model parameters are replaced. This means the User ID is checked and then the model parameters that are usually used for that user are loaded into the scoring algorithm before the scoring is performed. This procedure may be repeated for every obtained dataset of measurements.

It will now be described how the calculated perception score P can be used. The score may first be stored into a profile of the network or service asset. The score may also be updated after each scoring, either continuously or at certain intervals. Additional features may then be created based on that score. For example, a logic that detects sudden drops in the score may be used to generate alarms in the Network Operation Center. This indicates that the technical asset, such as a certain network node, is likely to “misbehave” in some way such that users may experience and perceive bad service that effectively reduces their satisfaction. When employing the solution and embodiments described herein it is an advantage that network nodes and other technical assets can be identified and repaired or upgraded if they really provide a bad experience to users, as indicated by the perception score P calculated for each asset. It is also possible to make more accurate prioritizations as explained above.

In conclusion, the perception score P calculated for a particular technical asset according to any of the embodiments described herein effectively expresses how satisfied users are with a service delivered by means of that asset. In this respect the resulting perception score P can thus be considered to be asset-specific, as indicated above.

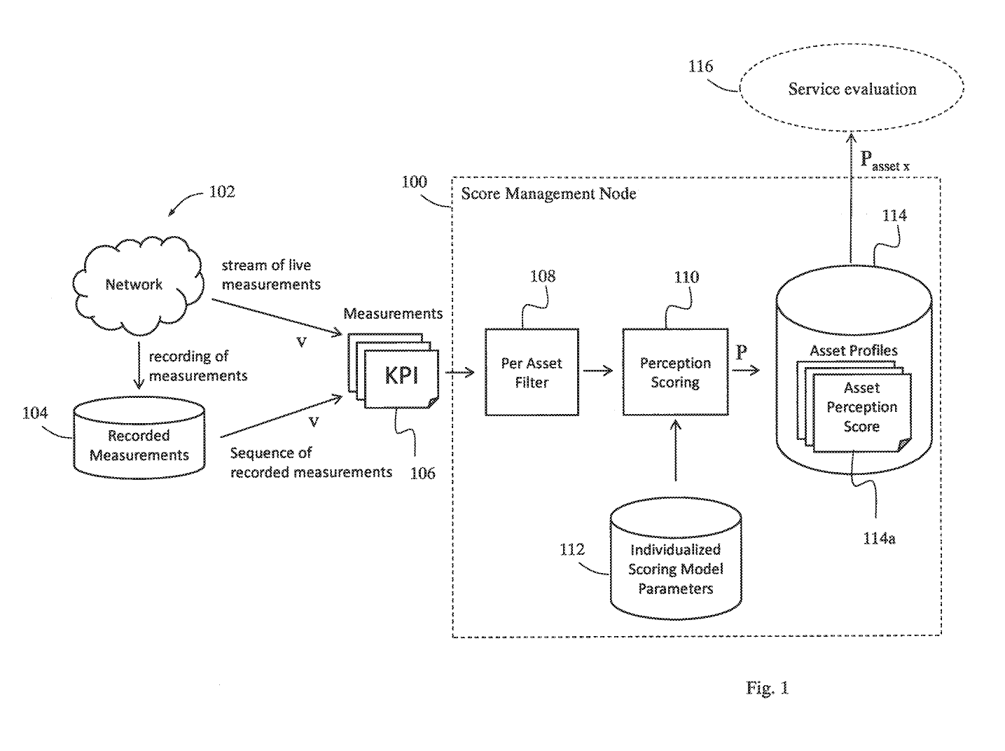

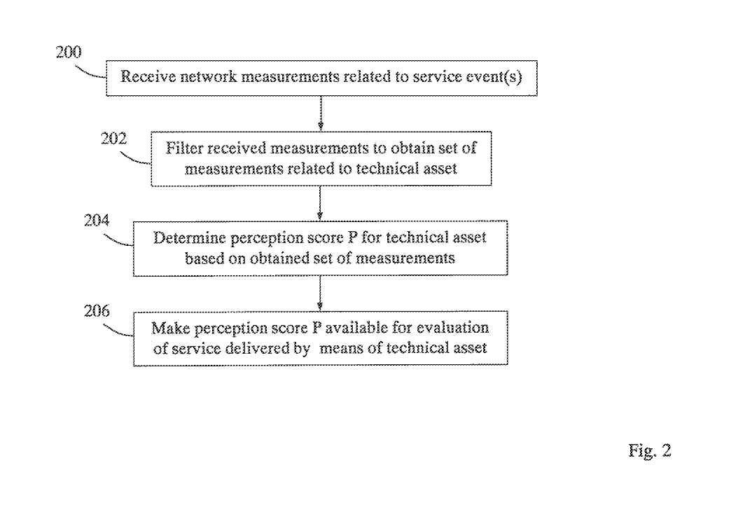

It will now be described how the perception score P can be generated by the score management node with reference to FIG. 1 and also to the flow chart in FIG. 2. FIG. 1 illustrates a score management node 100 which receives network measurements v made in a telecommunication network 102, while FIG. 2 illustrates a procedure with actions performed by the score management node 100, to accomplish the functionality described in this disclosure. The score management node 100 is operative to support service evaluation by obtaining a perception score P reflecting a user experience of a service delivered by means of a telecommunication network.

In this procedure, the network measurements v may be sent from the network 102 more or less in real-time in a “live stream” fashion, e.g. from an Operation & Maintenance, O&M, node or similar, not shown. Alternatively, the network measurements v may be recorded by the network 102 in a suitable storage or database 104 which can be accessed by the score management node 100, e.g. at regular intervals.

The received network measurements v can be seen as “raw data” being used as input to this procedure. For example, the above O&M node may be an aggregation point or node for receiving data from distributed sensors and probes that make measurements in the traffic flows throughout the network. This node may combine, correlate and generally process the measurement data in some way, e.g. to produce KPIs or the like.

A first action 200 illustrates that the score management node 100 receives network measurements v related to at least one service event when the service is delivered to one or more users. This operation may be performed in different ways, e.g. when the network 102 sends a stream of network measurements as they are generated, or by fetching network measurements from a measurement storage 104, as described above. Action 200 may thus be executed continuously or regularly any time during the course of this process of the following actions. The protocol used in this communication may be the hyper-text transfer protocol http or the file transfer protocol ftp, and the network measurements may be received in a message such as a regular http message or ftp message. In some possible embodiments, the score management node may thus receive the network measurements in a message according to the hyper-text transfer protocol http or the file transfer protocol ftp.

In some further possible but non-limiting embodiments, the network measurements may be related to any of: the time needed to download data, the time from service request until service delivery, call drop rate, data rate, and data error rate. In another possible embodiment, the network measurements may be made during a predefined time interval. FIG. 1 illustrates that the network measurements may be used to produce various KPIs 106 which are obtained by the score management node 100.

In a next action 202, the score management node 100 filters the received network measurements to obtain a set of asset related network measurements related to a specific technical asset in the network used for delivering the service. This action may be performed by applying a “per asset filter” 108 to the KPIs 106, as shown in FIG. 1, or directly to the received network measurements v. In another possible embodiment, the asset related network measurements may have been obtained from multiple service events of service delivery to users by means of said technical asset. In further possible embodiments, the technical asset may be any of: a radio network, a network node, a cell, a communication link, a communication protocol, a type of service, and an application server or service provider delivering the service.

The obtained set of asset related network measurements is then used as input in the next action 204 where the score management node 100 determines the perception score P for the technical asset based on the obtained set of asset related network measurements, which may be performed by a module for perception scoring 110 in the score management node 100.

In this action 204, the perception score P may according to another possible embodiment, be determined for the technical asset by applying a predefined scoring algorithm on the obtained set of asset related network measurements using a set of model scoring parameters in the scoring algorithm. As described above and according to another possible embodiment, the scoring model parameters may be individualized scoring model parameters, which may be maintained in a suitable storage 112, corresponding to expectations and perceptions of a specific user to which the service was delivered. Alternatively in another possible embodiment, the scoring model parameters may be predefined scoring model parameters corresponding to expectations and perceptions of an average user. In action 204, the perception score P may be calculated from the set of asset related network measurements in several different ways, and some illustrative but non-limiting examples of this will be described later below.

Finally, the calculated asset-specific perception score P is made available, in an action 206, for use in evaluation of the service delivered by means of the technical asset, e.g. by sending P to a service evaluation system, not shown, or by saving P in a storage 114 shown in FIG. 1. In this way, the parameter P may be determined exclusively for specific technical assets in the network, and different asset-specific perception scores may be maintained as a collection of asset profiles 114a in the storage 114. The protocol used for sending P to a service evaluation system may be e.g. the hyper-text transfer protocol http or the file transfer protocol ftp, and the perception score P may be sent to the service evaluation system in an http message or an ftp message over an IP network. The service evaluation system or storage may comprise an SQL (Structured Query Language) database or any other suitable type of database.

Some examples of how the above-described scoring module 110 may be implemented in practice will now be outlined. The scoring module 110 may be a piece of software executed by a suitable execution platform. This includes the possibility to have the scoring module compiled into one program. In this example, the scoring module may be a software module, e.g. in the form of Java classes, that is compiled into a single piece of software that contains the entire score calculation as exemplified above.

Alternatively, a potentially more flexible implementation may be used where the different operations described herein are treated as separate services implemented by distinct pieces of software. They could for example be Service-Oriented Architecture, SOA, Web Services. It would also possible to have the functions implemented as “worker nodes” in a stream processing environment such as “Storm”. In general, each functional module may be a logical scoring node that can be realized in software and can be either co-deployed on one physical node or separated and deployed into a set of physical processing nodes.

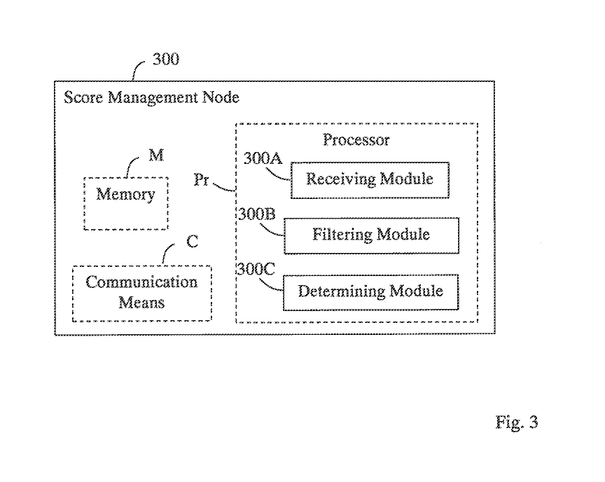

The block diagram in FIG. 3 illustrates another detailed but non-limiting example of how a score management node 300, which could be the above-described score management node 100 in FIG. 1, may be structured to bring about the above-described solution and embodiments thereof. In this figure, the score management node 300 may thus be configured to operate according to any of the examples and embodiments of employing the solution as described above, where appropriate, and as follows. The score management node 300 in this example is shown in a configuration that comprises a processor “Pr”, a memory “M” and a communication circuit “C” with suitable equipment for receiving and transmitting data and messages in the manner described herein.

The communication circuit C in the score management node 300 thus comprises equipment configured for communication with a telecommunication network, not shown, using one or more suitable communication protocols depending on implementation. As in the examples discussed above, the score management node 300 is configured or arranged to perform e.g. the actions of the flow chart illustrated in FIG. 2 in the manner described above. These actions may be performed by means of functional modules in the processor Pr in the score management node 300 as follows.

The score management node 300 is arranged to support service evaluation by obtaining a perception score P reflecting a user experience of a service delivered by means of a telecommunication network. The score management node 300 thus comprises the processor Pr and the memory M, said memory comprising instructions executable by said processor, whereby the score management node 300 is operable as follows.

The score management node 300 is configured to receive network measurements related to at least one service event when the service is delivered to one or more users. This receiving operation may be performed by a receiving module 300a in the score management node 300, e.g. in the manner described for action 200 above. The score management node 300 is also configured to filter the received network measurements to obtain a set of network measurements related to a specific technical asset in the network used for delivering the service. This filtering operation may be performed by a filtering module 300b in the score management node 300, e.g. in the manner described for action 202 above.

The score management node 300 is also configured to determine the perception score P for the technical asset based on the obtained set of network measurements, wherein the perception score P is made available for use in evaluation of the service delivered by means of the technical asset. This determining operation may be performed by a determining module 300c in the score management node 300, e.g. in the manner described for action 206 above.

It should be noted that FIG. 3 illustrates some possible functional units in the score management node 300 and the skilled person is able to implement these functional units in practice using suitable software and hardware. Thus, the solution is generally not limited to the shown structure of the score management node 300, and the functional modules 300a-c may be configured to operate according to any of the features described in this disclosure, where appropriate.

The embodiments and features described herein may thus be implemented in a computer program storage product comprising instructions which, when executed on at least one processor, cause the at least one processor to carry out the above actions e.g. as described for any of FIGS. 1-3. Some examples of how the computer program storage product can be realized in practice are outlined below, and with further reference to FIG. 3.

The processor Pr may comprise a single Central Processing Unit (CPU), or could comprise two or more processing units. For example, the processor Pr may include a general purpose microprocessor, an instruction set processor and/or related chips sets and/or a special purpose microprocessor such as an Application Specific Integrated Circuit (ASIC). The processor Pr may also comprise a storage for caching purposes.

The memory M may comprise the above-mentioned computer readable storage medium or carrier on which the computer program is stored e.g. in the form of computer program modules or the like. For example, the memory M may be a flash memory, a Random-Access Memory (RAM), a Read-Only Memory (ROM) or an Electrically Erasable Programmable ROM (EEPROM). The program modules could in alternative embodiments be distributed on different computer program products in the form of memories within the score management node 300.

When using any of the embodiments described herein, the perception score P can be used in the service evaluation as an estimation of the users' opinion and it is possible to obtain P automatically after every time a service is delivered to a user. Further, since the perception score P is calculated from technical measurements in the network related to a specific technical asset in the network used for delivering the service, it is possible to evaluate the performance of that asset based on the perception score P. Since the calculated P is thus “asset-specific”, any technical asset in the network that performs less than satisfactorily can be identified and remedied to improve the service delivery.

It was mentioned above that the score management node 100 determines the perception score P for the technical asset based on the obtained set of asset related network measurements, as of action 204. Some examples of how this could be done will now be described in more detail, which refer to “network measurements” in general which more specifically can be the above-described set of asset related network measurements.

An example of a procedure will thus now be described for how the perception score P may be determined by the score management node based on network measurements which could thus be the above-mentioned set of asset related network measurements.

The perception score P may be determined by the score management node as follows. The received network measurements v can be seen as “raw data” being used as input in this procedure. In this example, a quality score Q reflecting the user's perception of quality of a delivered service and an associated significance S reflecting the user's perception of importance of the delivered service, are determined based on the network measurements. In this operation, Q and S may be determined by applying predefined functions on the network measurements, which will be explained in more detail later below. The perception score P is then derived from the quality score Q which is weighted by its associated significance S. Basically, the greater significance S the greater influence has the associated quality score Q on the resulting perception score P.

Before calculating the perception score P, the quality score Q and associated significance S may also be modified in this procedure based on a set of predefined influence factors valid for the user and the delivered service. These influence factors may be related to user expectation considering various characteristics of the user, correlation of different service events occurring within a certain time frame, and fading memory of the user which reduces the significance S of a service event over time. The perception score P is then calculated from the modified quality score Q and associated significance S, and the resulting perception score P can then be made available for supporting evaluation of the service. By using this procedure, the perception score P can be seen as a model for how the user is expected to perceive the service given the circumstances of the delivered service, which model is based on objective and technical network measurements.

Next, the operation of modifying Q and S according to the above influence factors is performed. In this way, Q and S are determined purely from the raw data, i.e. the received network measurements, while Q and S are adjusted by considering the circumstances of the service event which produce the above influence factors, thereby making Q and S more adapted to the actual situation of the delivered service.

Further, the operation of calculating the perception score P from the modified Qm weighted by its associated and modified Sm is performed. Having generated the resulting perception score P, the score management node makes P available for evaluation of the service, e.g. by saving it in a suitable storage or sending it to a service evaluation system or center. For example, P may be sent to the service evaluation system or storage in an http message or an ftp message over an IP network. The service evaluation system or storage may comprise an SQL (Structured Query Language) database or any other suitable type of database.

The quality score Q and associated significance S are thus modified gradually in multiple steps such that the output of modified Q′ and/or S′ is used as input for further modification, until the thus processed data is used for calculation of P.

There are several advantages of this procedure as compared to conventional ways of obtaining a user's opinion about a service. First, the perception score P is a quite accurate estimation of the users' opinion of the service event considering the prevailing circumstances, and it is possible to obtain P automatically and continuously in real-time, basically after every time a service is delivered to a user. There are thus no restrictions regarding the number of users nor the extension of time which makes it possible to obtain a quite representative perception score P. Second, the perception score P is calculated from technical measurements made in the network related to the service usage which are truthful and “objective” as such, also being readily available, thereby avoiding any dependency on the user's memory and willingness to answer a survey or the like. Third, it is not necessary to spend time and efforts to distribute surveys and to collect and evaluate responses, which may require at least a certain amount of manual work.

Fourth, it is possible to gain further knowledge about the service by determining the perception score P selectively, e.g. for specific types of services, specific types of network measurements, specific users or categories of users, and so forth. Fifth, it is also possible to trace a technical issue that may have caused a “bad” experience of a delivered service by identifying which measurement(s) have generated a low perception score P. It can thus be determined when and how a service was delivered to a presumably dissatisfied user, as indicated by the perception score P, and therefore a likely technical shortcoming that has caused the user's dissatisfaction can also be more easily identified. Once found, the technical issue can be eliminated or repaired. Different needs for improvement of services can also be prioritized based on the knowledge obtained by the perception score P.

It was mentioned above that Q and S may be determined by applying predefined functions on the network measurements. For example, Q may be determined by applying a first function Q(v) on the network measurements v, and S may be determined by applying a second function S(v) on the network measurements v. Further, the first and second predefined functions Q(v) and S(v) may be dependent on a type of the network measurements used as input to the functions so that a function applied on, say, measurement of data rate is different from a function applied on measurement of call drop rate, to mention two non-limiting but illustrative examples.

The score management node may then modify the determined quality score Q and associated significance S of each service event based on a predefined influence factor applied in each intermediate scoring module. This means that Q and S, or at least one of Q and S, may be modified based on a first predefined influence factor. The once modified Q′ and S′ may then be modified further based on a second predefined influence factor. The twice modified Q″ and S″ may then be modified further based on a third predefined influence factor, and so forth. Any number of such influence factors may be used.

The predefined influence factors may comprise at least two of:

(a) User expectation. In this example, a user profile with characteristics pertaining to the user is defined and at least one user group that matches the user profile is identified. The quality score Q and associated significance S can then be modified based on predefined group-specific parameters valid for the at least one identified user group. The group-specific parameters have thus been defined for a user group to basically describe the user group. Thus, the user can thereby be described by means of membership in one or more of these user groups depending on how relevant the group-specific parameters are to the user.

(b) Correlation of different service events. In this example, the significance S of a quality score Q for a first service event is modified by multiplying a correlation factor F reflecting a correlation between the first service event and a second service event when the first and second service events have both occurred within a certain time frame. For example, the correlation factor F may be greater the closer two service events are in time assuming that if one of the events has particularly high significance to the user the other event will also be likely to have high significance to the user if the two service events occur within a short time frame.

(c) Fading memory of the user. In this example, the significance S of each quality score Q is reduced over time according to a predefined Significance Reduction Rate, SRR assuming that a user's memory of a service event tends to fade over time and this can be compensated by reducing the significance of the service event over time accordingly. By reducing the significance S over time to simulate the user's fading memory of the service event, the perception score P will likewise be reduced over time. The SRR may be defined to form a step-like function which reduces S in distinct steps over time until it finally reaches zero assuming that the service event is virtually forgotten by the user at this point.

In this way, Q and S have been modified according to the predefined influence factors as exemplified above and the resulting modified quality score “Qm” and associated significance “Sm” are used as input in the next action where the score management node calculates the perception score P based on the modified quality score Qm and associated modified significance Sm. Finally, the calculated perception score P may be made available for use in the service evaluation, e.g. by sending P to a suitable service evaluation system or storage. The protocol used in this communication may be e.g. the hyper-text transfer protocol http or the file transfer protocol ftp, and the perception score P may be sent to the service evaluation system or storage in an http message or an ftp message over an IP network. The service evaluation system or storage may comprise an SQL (Structured Query Language) database or any other suitable type of database.

The perception score P may be calculated according to different possible procedures as follows. In one example, the score management node may calculate the perception score P for multiple service events of service delivery to the user as an average of modified quality scores Qm for the service events weighted by their associated modified significances Sm. In this case, the score management node may calculate the perception score P_{N} for N service events of service delivery to the user according to the following formula:

$${P}_{N} = \frac{{\sum }_{n = 1}^{N} {Q}_{n} {S}_{n}}{{\sum }_{n = 1}^{N} {S}_{n}}$$

where Qₙ is the modified quality score for a service event n and Sₙ is the associated modified significance for said service event n. In other words, the sum of all N quality scores weighted by their significances is divided by the sum of all the N significances.

The network measurements may be made during a predefined time interval. Further, the score management node may update the perception score P after a new service event n based on a previous perception score Pₙ₋₁ calculated for a previous time interval or service event and a quality score Qₙ and associated significance Sₙ determined for the new service event n, according to the following formula:

$${P}_{n} = \frac{{P}_{n - 1} {S}_{sum , n - 1} + {Q}_{n} {S}_{n}}{{S}_{sum , n - 1} + {S}_{n}}$$

where S_{sum,n}=S_{sum,n-1} and Pₙ is the updated perception score. In this way, the perception score P can be kept up-to-date after each new service event by using the above simple calculation which adds the influence of the new service event n on the total P.

In further examples, the score management node may identify at least one type of service for which a modified significance S satisfies a threshold condition. If so, the score management node may then provide the identified at least one type of service as input to root cause analysis when the perception score P is changed significantly. The term “root cause analysis” refers to a procedure for tracing a technical reason for why a service has e.g. been delivered poorly, which procedure as such is somewhat outside the scope of this disclosure. In this embodiment the root cause analysis is deemed to be warranted if the perception score P has changed significantly, particularly when P has decreased which indicates that the user is expected to be dissatisfied with the service as shown by the network measurement(s).

The threshold condition is thus used for finding service events of unexpected perception score P, either surprisingly low or high. This also makes it easy to exactly identify individual service events that may have caused a “bad” experience of a delivered service. For example, the threshold condition may require that the modified significance S is high which indicates that the corresponding service event has had a great influence on the changed P. Thereby, the search for a technical reason can be focused on that service event to some extent.

It was mentioned above that the score management node may identify at least one type of service for which a modified significance S satisfies a threshold condition, and that the identified at least one type of service may then be provided as input to root cause analysis when the perception score P is changed significantly. Examples of how this can be done will now be described. It is assumed that the resulting modified significance S can be detected and collected, e.g. the output from the last intermediate scoring module being the modified significance Sm, in order to generate a table with services that have generated the highest significances as follows.

The final modified significance S of a single service event may thus be used in order to determine what type of service did get the highest overall significance. In this case the significances determined for a certain service type are summed up and the sum value is stored. In this way, a significance table can be built that shows which types of services did have the highest significance in the calculation of the perception score. The significance table can be sorted according to the significance sums resulting in a list with the most significant service event on top of the list. This shows what type of service has produced the highest weight in the calculation of the perception score P.

An example of such a significance table comprises entries for different service types and their resulting significance sum, the number of scorings of service events and a calculated average of the significance for all service events. Whenever a new scoring for a service type Tx with a significance S is obtained, S is added to the significance sum S_Tx of the service type Tx. In this table, also the number of scorings and the average significance are kept for each service type. This provides further information indicating whether the significance of a service type is coming from a small number of very significant service events or from a large number of less significant ones. This may provide further insights into the service event history of the user and the root cause for the perception score.

A table like this is associated with the perception score P. Thus for every perception score P, a table of the most significant experience events can be made available. As similar to the perception score P, this table is user specific and this kind of table can be generated for each user.

It may be of interest to find out why the perception score P has increased or declined, and this significance table can indicate what types of services had the greatest influence on changes in the perception score. Further investigations in the root cause analysis can then focus on these service types accordingly.

Another example of a procedure will now be described for how the perception score P may be determined by the score management node based on network measurements which could thus be the above-mentioned set of asset related network measurements.

In this example, a quality score Q reflecting the user's perception of quality of a delivered service, is determined by applying a first function Q(v) on the network measurements v. Further, an associated significance S reflecting the user's perception of importance of the delivered service, is also determined by applying a second function S(v) on the network measurements v. The quality score Q and its associated significance S may be determined in this manner for each network measurement by the score management node. The above-mentioned first and second functions Q(v), S(v) may be predefined for a particular measurement type and they may be maintained in the score management node. Different variants of the first and second functions Q(v), S(v) may thus be maintained for different measurement types which will be described in more detail later below.

The perception score P of the received network measurements v is then derived from the quality scores Q which are weighted by their associated significances S. Basically, the greater significance S the greater influence has the associated quality score Q on the resulting perception score P. This example is directed to describe how the above quality score Q, significance S and perception score P can be determined.

Before calculating the perception score P, one or both of the quality score Q and associated significance S may be modified in this procedure depending on whether the quality score Q determined for a new service delivery event deviates significantly from a “normal”, i.e. expected, level of the perception score P calculated previously. For example, the user may be assumed to expect basically the same level of quality “as usual” whenever a service is delivered. If the quality, as determined from one or more network measurements of a new service delivery event, suddenly departs from the expected level, the user can further be assumed to be “surprised” by the unexpected quality level and e.g. the significance S of that event may therefore be increased.

The score management node may further operate to modify the quality score Q and its associated significance S in order to compensate for various circumstances at the respective service delivery, e.g. including the user's expectations of the service delivery as mentioned above. The user's expectations are basically indicated by a previously determined overall perception score valid for one or more previous service deliveries. For example, one or both of the quality score Q and the associated significance S may be modified assuming that Q and/or S of a new service event may be impacted depending on a deviation between the new quality score Q and a previous perception score P, which deviation effectively reflects a degree of assumed “surprise” to the user.

Having generated the resulting perception score P, the score management node makes P available for evaluation of the service, e.g. by saving it in a suitable storage or sending it to a service evaluation system or center. By using this procedure, the perception score P can be seen as a model for how the user is expected to perceive the service given the circumstances of the delivered service, which model is based on objective network measurements. Thus, P is a quantification of the user's assumed perception of the service deliveries.

There are several advantages of this procedure as compared to conventional ways of obtaining a user's opinion about a service. First, the perception score P is a quite accurate estimation of the users' opinion of the service event considering the prevailing circumstances, and it is possible to obtain P automatically and continuously in real-time, basically after every time a service is delivered to a user. There are thus no restrictions regarding the number of users nor the extension of time which makes it possible to obtain a quite representative perception score P. Second, the perception score P is calculated from technical measurements in the network related to the service usage which are true and “objective” as such, also being readily available, thereby avoiding any dependency on the user's memory and willingness to answer a survey or the like. Third, it is not necessary to spend time and efforts to distribute surveys and to collect and evaluate responses, which may require at least a certain amount of manual work.

Fourth, it is possible to gain further knowledge about the service by determining the perception score P selectively, e.g. for specific types of services, specific types of network measurements, specific users or categories of users, and so forth. Fifth, it is also possible to trace a technical issue that may have caused a “bad” experience of a delivered service by identifying which measurement(s) have generated a low perception score P. It can thus be determined when and how a service was delivered to a presumably dissatisfied user, as indicated by the perception score P, and therefore a likely technical shortcoming that has caused the user's dissatisfaction can also be more easily identified. Once found, the technical issue can be eliminated or repaired. Different needs for improvement of services can also be prioritized based on the knowledge obtained by the perception score P. Further features and advantages will be evident in the description of examples that follows.

The score management node may comprise various scoring modules which may be a suitable configuration for enabling the examples described herein. Each scoring module may be a piece of software executed by a suitable execution platform. This includes the possibility to have all scoring modules compiled into one program. In this example, the scoring modules may be software modules, e.g. in the form of Java classes, that are compiled together into a single piece of software that contains the entire score calculation as exemplified above. A scoring coordinator may be used for controlling the operation of each scoring mode.

Alternatively, a potentially more flexible implementation may be used where the scoring modules are treated as separate services implemented by distinct pieces of software. They could for example be Service-Oriented Architecture, SOA, Web Services. It would also possible to have the scoring modules implemented as “worker nodes” in a stream processing environment such as “Storm”. In general, each scoring module is a logical scoring node that can be realized in software and can be either co-deployed on one physical node or separated and deployed into a set of physical processing nodes.

It was mentioned above that different variants of the first and second functions may thus have been predefined for different network measurement types, e.g. being maintained in the score management node. For example, a variant of function Q(v) or S(v) applied on, say, a measurement of data rate is different from a variant of function Q(v) or S(v) applied on a measurement of call drop rate, to mention a non-limiting but illustrative example.

In another example, the score management node may maintain associations between different network measurement types and different variants of the first and second functions, e.g. in a suitable document or data storage. In this example, the score management node may select a variant of the first and second functions according to said associations for determining the quality score Q and associated significance S for each network measurement. When receiving a network measurement, the score management node is thus able to identify the type of the network measurement and select a variant of the first and second functions according to the identified measurement type. In further examples, each of the first and second functions may be a discrete function or a continuous function.

In a possible example, the score management node may determine multiple pairs of the quality score Q and associated significance S based on the network measurements, e.g. one pair for each network measurement. A pair of Q and S is thus determined for each service event based on the network measurement for that service event. The score management node may then calculate the perception score P as an average of the quality scores Q weighted by their associated significances S in all the above pairs of Q and S. In a further example, this may be done such that when the number of service events is N, the score management node calculates the perception score P_{N} for the N events of service delivery to the user as

$${P}_{N} = \frac{{\sum }_{n = 1}^{N} {Q}_{n} {S}_{n}}{{\sum }_{n = 1}^{N} {S}_{n}}$$

where Qₙ is the quality score determined for each service event n and Sₙ is the associated significance determined for said service event n. In other words, the sum of all N quality scores weighted by their significances is divided by the sum of all the N significances. Thereby, the quality score Qₙ for each service event n will impact the overall perception score P_{N} according to its associated significance Sₙ and P_{N} will thus become an accurate representation of the user's perception of quality of service delivery across all service events N. These examples may have the advantage that a perception score can be obtained that reflects the user's experience of a service over a specific selection of service events N. The overall perception score P_{N} may thus be calculated for any selection of service events N as desired.

Alternatively, an “accumulated” perception score P may be obtained and updated after each new service event as follows. Thus in another example, the score management node may update the perception score P after a new service event n based on a previous perception score Pₙ₋₁ calculated for a previous time interval or service event and a quality score Qₙ and associated significance Sₙ determined for the new service event n, as

$${P}_{n} = \frac{{P}_{n - 1} {S}_{sum , n - 1} + {Q}_{n} {S}_{n}}{{S}_{sum , n - 1} + {S}_{n}}$$

$$where$$

$${S}_{sum , n} = {\sum }_{n = 1}^{N} {S}_{n}$$

and Pₙ is the updated perception score. In this way, the perception score P can be kept up-to-date after each new service event by using the above simple calculation which adds the influence of the new service event n on the total P. This example may have the advantage that the updated perception score Pₙ reflects the user's experience of a service in a “continuous” manner by always taking the latest service event into account.

In yet another example, the score management node may determine the perception score P for a service of a particular type by calculating the perception score P according to the above procedure for multiple users upon service delivery to the users with a service of said particular type. The additional information provided by this example may be used to support or facilitate tracing of any technical issue that may cause a low perception score P for the particular service type.

It was mentioned above that the score management node may maintain associations between the respective network measurement types and the variants of the first and second functions Q(v), S(v). Such variants of the functions may be associated with network measurement types in a table where a variant Q1(v) of the first function and a variant S1(v) of the second function are associated with a measurement “type 1”. Further, another variant Q2(v) of the first function and another variant S2(v) of the second function are associated with another measurement “type 2”, and so forth. By identifying the measurement type of an incoming network measurement, the score management node can thus find the correct variants of the first and second functions Q(v), S(v) in this table and apply them accordingly to determine Q and S.

Another table may comprise variants of the functions Q(v) and S(v) for two network measurement types, video-frame rate and the time needed to download a web page. It was further mentioned above that either of the first and second functions may be a discrete function or a continuous function. Thus, each of the first function Q(v) and the second function S(v) may be a discrete function for the measurement type video-frame rate, such that Q increases and S decreases in discrete steps upon increased video-frame rate v. Q may increase in discrete steps upon increased video-frame rate v in frames per second, fps. For example, Q=0 when v is lower than 10, Q=1 when v is between 10 and 15, Q=2 when v is between 15 and 20, Q=3 when v is between 20 and 25, and Q=4 when v is higher than 25. On the other hand, each of the first function Q(v) and the second function S(v) may be a continuous function for the measurement type time needed to download a web page, meaning that Q decreases and S increases continuously upon increased time needed to download a web page.

It should be noted that the functions Q(v) and S(v) for the measurement type video-frame rate produce higher Q and lower S values the higher the video-frame rate is, while the functions Q(v) and S(v) for the measurement type video-frame rate produce lower Q and higher S values the longer time needed to download a web page. By these variants of functions Q(v) and S(v), it is assumed that Q is relatively low and S is relatively high when the network measurement v indicates “bad” quality, either by low video-frame rate or by higher the time needed to download a web page, and vice versa.

While the solution has been described with reference to specific exemplifying embodiments, the description is generally only intended to illustrate the inventive concept and should not be taken as limiting the scope of the solution. For example, the terms “score management node”, “network measurement”, “scoring module”, “service event”, “technical asset”, “scoring algorithm” and “scoring model parameters” have been used throughout this disclosure, although any other corresponding entities, functions, and/or parameters could also be used having the features and characteristics described here. The solution is defined by the appended claims.

1. A method performed by a score management node for supporting service evaluation by obtaining a perception score P reflecting a user experience of a service delivered by means of a telecommunication network, the method comprising:
receiving network measurements related to at least one service event when the service is delivered to one or more users,
filtering the received network measurements to obtain a set of asset related network measurements related to a specific technical asset in the network used for delivering the service, and
determining the perception score P for the technical asset based on the obtained set of asset related network measurements, wherein the perception score P is made available for use in evaluation of the service delivered by means of the technical asset.

2. The method of claim 1, wherein the asset related network measurements have been obtained from multiple service events of service delivery to users by means of said technical asset.

3. The method of claim 1, wherein the technical asset is any of: a radio network, a network node, a cell, a communication link, a communication protocol, a type of service, and an application server or service provider delivering the service.

4. The method of claim 1, wherein the received network measurements are related to any of: the time needed to download data, the time from service request until service delivery, call drop rate, data rate, and data error rate.

5. The method of claim 1, wherein the perception score P is determined for the technical asset by applying a predefined scoring algorithm on the obtained set of asset related network measurements using a set of scoring model parameters in the scoring algorithm.

6. The method of claim 5, wherein the scoring model parameters are individualized scoring model parameters corresponding to expectations and perceptions of a specific user to which the service was delivered.

7. The method of claim 5, wherein the scoring model parameters are predefined scoring model parameters corresponding to expectations and perceptions of an average user.

8. The method of claim 1, wherein the received network measurements are made during a predefined time interval.

9. The method of claim 1, wherein the network measurements are received in a message according to the hyper-text transfer protocol http or the file transfer protocol ftp.

10. A score management node arranged to support service evaluation by obtaining a perception score P reflecting a user experience of a service delivered by means of a telecommunication network, the score management node comprising a processor and a memory containing instructions executable by the processor, whereby the score management node is configured to:
receive network measurements related to at least one service event when the service is delivered to one or more users;
filter the received network measurements to obtain a set of asset related network measurements related to a specific technical asset in the network used for delivering the service; and
determine the perception score P for the technical asset based on the obtained set of asset related network measurements, wherein the perception score P is made available for use in evaluation of the service delivered by means of the technical asset.

11. The score management node of claim 10, wherein the score management node is configured to determine the perception score P based on network measurements related to the technical asset which have been obtained from multiple service events of service delivery to users.

12. The score management node of claim 10, wherein the technical asset is any of: a radio network, a network node, a cell, a communication link, a communication protocol, a type of service, an application server or service provider delivering the service.

13. The score management node of claim 10, wherein the network measurements are related to any of: the time needed to download data, the time from service request until service delivery, call drop rate, data rate, and data error rate.

14. The score management node of claim 10, wherein the score management node is configured to determine the perception score P for the technical asset by applying a predefined scoring algorithm on the obtained set of asset related network measurements using a set of scoring model parameters in the scoring algorithm.

15. The score management node of claim 14, wherein the scoring model parameters are individualized scoring model parameters corresponding to expectations and perceptions of a specific user to which the service was delivered.

16. The score management node of claim 14, wherein the scoring model parameters are predefined scoring model parameters corresponding to expectations and perceptions of an average user.

17. The score management node of claim 10, wherein the score management node is configured to receive network measurements made during a predefined time interval.

18. The score management node of claim 10, wherein the score management node is configured to receive the network measurements in a message according to the hyper-text transfer protocol http or the file transfer protocol ftp.

19. A computer program product comprising a non-transitory computer readable medium storing instructions which, when executed on at least one processor, cause the at least one processor to carry out the method of claim 1.
